(19) United States
(12) Patent Application Publication
(10) Pub. No.: US 2025/0202752 A1
(43) Pub. Date: Jun. 19, 2025

(54) SINGLE SIDEBAND DFT-S-OFDM

(71) Applicant: HUAWEI TECHNOLOGIES CO., LTD., Shenzhen (CN)

(72) Inventor: Fredrik Berggren, Kista (SE)

(73) Assignee: HUAWEI TECHNOLOGIES CO., LTD., Shenzhen (CN)

(21) Appl. No.: 19/063,490

(22) Filed: Feb. 26, 2025

Related U.S. Application Data
(63) Continuation of application No. PCT/EP2022/073829, filed on Aug. 26, 2022.

(51) Int. Cl. H04L 27/26; H04J 13/00

(52) U.S. Cl. CPC H04L 27/2636; H04J 13/0062; H04L 27/2605

(57) ABSTRACT

A signal transmission apparatus configured for transmission of modulation symbols utilizing orthogonal frequency-division multiplexing, OFDM, based on Discrete Fourier Transform, DFT, precoding. The signal transmission apparatus is configured to generate a DFT spread OFDM (DFT-s-OFDM) signal by receiving an input (x[m]) comprising M modulation symbols for m=0, 1, . . . , M−1 and phase-shifting the input (x[m]) thereby generating a phase-shifted input (\acute{x}[m]). The signal transmission apparatus is configured for precoding the phase-shifted input utilizing DFT, thereby generating M Fourier coefficients (X[k]) and ordering the Fourier coefficients and selecting M/2 Fourier coefficients. The signal transmission apparatus is configured for generating the DFT-s-OFDM signal based on the M/2 selected Fourier coefficients.

### CROSS-REFERENCE TO RELATED APPLICATIONS

This application is a continuation of International Application No. PCT/EP2022/073829, filed on Aug. 26, 2022, the disclosure of which is hereby incorporated by reference in its entirety.

### TECHNICAL FIELD

The present disclosure relates generally to the field of communication systems and more specifically, to a signal transmission apparatus and a method for use in the signal transmission apparatus.

### BACKGROUND

Generally, the third-generation partnership project (3GPP) long term evolution (LTE) and new radio (NR) systems support quadrature phase shift keying (QPSK) modulation technique. The QPSK is used in both uplink and downlink, for all control channels and the data channels. Due to low spectral efficiency and high reliability, the QPSK is preferred for communication of moderate payloads, for example, control messages or small transport blocks. The LTE and NR also support binary phase shift keying (BPSK) modulation technique for uplink control channels. Moreover, the NR supports π/2-BPSK modulation for uplink control channels and uplink data channel. The BPSK and π/2-BPSK modulation techniques carry one bit per symbol and are therefore used for low-rate communications. Further, the π/2-BPSK modulation is only supported with discrete Fourier transform spread orthogonal frequency division multiplexing (DFT-s-OFDM) and is introduced for coverage limited transmissions, where low transmit power backoff is desirable. The DFT-s-OFDM is also used for optical transmission systems and in combination with pulse amplitude modulation (PAM), for example, 4-PAM. The benefits of PAM, such as BPSK, is low complexity, which is beneficial for both transmitter and receiver implementations. On the other hand, the drawback is low spectral efficiency, which can be increased by using, e.g., M-ary PAM (M-PAM). However, higher order PAM is not widely used in commercial cellular systems and requires an increased SNR compared to quadrature amplitude modulation (QAM). Therefore, QPSK modulation, which has twice the spectral efficiency of BPSK, is commonly used.

The spectral efficiency of PAM (e.g., BPSK) may be improved by use of single sideband (SSB) transmission. The SSB version of a signal occupies half the bandwidth of the original signal but still carries the same amount of information. Consequently, the spectral efficiency is doubled. Moreover, the SSB transmission is used in photonics and optics (e.g., radio-over-fibre (RoF)), and also combined with OFDM to provide large data rates in fibres. An issue is that the SSB transmission yields inter-symbol interference (ISI) for QAM, e.g., QPSK, hence, advanced signal processing and ISI cancellation is required. However, for one-dimensional modulation, e.g., PAM, there is no ISI and the SSB transmission can be utilized without ISI cancellation. For DFT-s-OFDM, the bit error rate (BER) of higher order M-PAM with SSB transmission is the same as 2M-QAM without SSB transmission, under the assumption of perfect channel equalization and time-invariant channel. The QPSK with DFT-s-OFDM is widely used in cellular communications. The proposed solutions have shown that under certain conditions, BPSK with SSB transmission has the same BER and better peak-to-average-power ratio (PAPR) than QPSK. Moreover, in the conventional DFT-s-OFDM, the modulation symbols are time-multiplexed only. Further the SSB transmission in the conventional DFT-s-OFDM manifests inflexibility and relies on several restrictions. Thus, there exists a technical challenge of exploiting the full potential of SSB transmission with the DFT-s-OFDM.

Therefore, in light of the foregoing discussion, there exists a need to overcome the aforementioned drawbacks associated with using the SSB transmission with the conventional DFT-s-OFDM.

### SUMMARY

The present disclosure provides a signal transmission apparatus and a method for use in the signal transmission apparatus. The present disclosure provides a solution to the existing problem of inflexibility and several restrictions associated with using the SSB transmission with the conventional DFT-s-OFDM. An aim of the present disclosure is to provide a solution that overcomes at least partially the problems encountered in the prior art and provide an improved signal transmission apparatus and an improved method for use in signal transmission apparatus for achieving more reliability and spectral efficiency.

One or more objects of the present disclosure are achieved by the solutions provided in the enclosed independent claims. Advantageous implementations of the present disclosure are further defined in the dependent claims.

In one aspect, the present disclosure provides a signal transmission apparatus configured for transmission of modulation symbols utilizing orthogonal frequency-division multiplexing, OFDM, based on Discrete Fourier Transform, DFT, precoding. The signal transmission apparatus is further configured to generate a DFT-s-OFDM signal by receiving an input (x[m]) comprising M modulation symbols for m=0, 1, . . . , M−1, where M is an even number. The signal transmission apparatus is further configured for phase-shifting the input (x[m]) thereby generating a phase-shifted input (\acute{x}[m]). The signal transmission apparatus is further configured for precoding the phase-shifted input utilizing DFT, thereby generating M Fourier coefficients (X[k]) and ordering the Fourier coefficients and selecting M/2 Fourier coefficients. The signal transmission apparatus is further configured for generating the DFT-s-OFDM signal based on the M/2 selected Fourier coefficients.

The disclosed signal transmission apparatus enables use of full potential of SSB transmission with the DFT-s-OFDM, the reason being in the DFT-s-OFDM signal with SSB transmission, by the ordering and selection of the Fourier coefficients, the modulation symbols are multiplexed over both time and frequency domain, which is in contrast to conventional DFT-s-OFDM where the modulation symbols are multiplexed over time domain only. This is advantageous in terms of providing diversity gains in time-frequency selective channels. Moreover, the signal transmission apparatus manifests improved block error rate (BLER) and peak-to-average power ratio (PAPR) by virtue of ordering and selection of the Fourier coefficients.

In an implementation form, the generated DFT-s-OFDM signal additionally comprises a cyclic prefix.

By virtue of the cyclic prefix, the DFT-s-OFDM signal manifests robustness.

In a further implementation form, the signal transmission apparatus being characterized in that the time-discrete low-pass equivalent signal is generated by:

$$s [ n ] = \frac{1}{\sqrt{N}} {\sum }_{k = 0}^{M / 2 - 1} X [ g [ k ] ] {e}^{j \frac{2 π}{N} n q [ k ]} , n = 0 , 1 , … , N - 1$$

wherein N denotes the number of time samples, the q[k] is a function which maps Fourier coefficients to subcarriers, and wherein g[k] is a function for selecting and ordering the Fourier coefficients.

By virtue of the selection and ordering of the Fourier coefficients, the orthogonality condition is maintained.

In a further implementation form, the g[k] function is defined as:

$$g [ k ] = f [ h [ k ] ]$$

$$with the function$$

$$f [ i ] = {f}_{1} i + {f}_{0} ( mod M )$$

$$and the function$$

$$h [ k ] = k + M / P ⌊ k / ( M / P ) ⌋$$

wherein M/P and P are integers and also the coefficients ƒ₁ and ƒ₀ are integers, for which the greatest common divisor of ƒ₁ and M is 1, and k=0, 1, . . . , M/2−1, and (mod M) denotes addition modulo M and └.┘ denotes the floor function.

In a further implementation form, P is set to 1 and ƒ₁ is set to 2.

In a further implementation form, P is set to M and ƒₜ is set as the smallest integer larger than 1 such that the greatest common divisor of ƒₜ and M is 1.

In a further implementation form, the function ƒ[i] is arranged to produce other indices than the corresponding h[k].

In a further implementation form, the signal transmission apparatus according to any preceding claim, wherein the phase-shift for modulation symbol m is obtained from the complex exponential function e^{j(αm}^{²}^{+βm+γ)} and the phase-shifted input (\acute{x}[m]) is determined by:

$${x}^{´} [ m ] = {e}^{j ( α {m}^{2} + β m + γ )} x [ m ] , m = 0 , 1 , … , M - 1$$

wherein α, β and γ are real-valued.

In a further implementation form, parameters of the function g[k] are determined to provide orthogonal signalling, by fulfilling:

$$C \cdot Re \{ {\sum }_{n = 0}^{M - 1} w [ m , n ] w * [ p , n ] \} = δ [ m - p ]$$

where C is a constant, δ[t] is the Kronecker delta function for an integer t, Re{ } is the real-part operator and * denotes complex conjugate, wherein w[m, n] is defined for m=0, 1, . . . , M−1 and n=0, 1, . . . , N−1 as:

$$w [ m , n ] = \frac{1}{M} {\sum }_{k = 0}^{M / 2 - 1} {e}^{j ( α {m}^{2} + β m + γ )} {e}^{- j \frac{2 π}{M} g [ k ] m} {e}^{j \frac{2 π}{M} q [ k ] n}$$

In a further implementation form, the mapping q[k] is to a set of contiguous sub carriers.

In a further implementation form, the mapping q[k] is to a set of non-contiguous subcarriers.

In a further implementation form, the input symbols (x[m]) are real-valued modulation symbols.

In a further implementation form, the input symbols (x[m]) are based on a π/2-rotated Pulse Amplitude Modulation, PAM, scheme, wherein a=0, β=π/2, P=1 and ƒ₁=1, with ƒ₀=(M+2)/4.

The use of the π/2-rotated Pulse Amplitude Modulation (e.g., π/2 BPSK) satisfies the orthogonality condition.

In a further implementation form, the input symbols (x[m]) are based on a Zadoff-Chu sequence.

The use of the Zadoff-Chu sequence enables chirp sequence transmission.

In another aspect, the present disclosure provides a method for use in a signal transmission apparatus configured for transmission of modulation symbols utilizing orthogonal frequency-division multiplexing, OFDM, based on Discrete Fourier Transform, DFT, precoding. The method comprises generating a DFT-s-OFDM signal by receiving an input (x[m]) comprising M modulation symbols, where M is an even number. The method further comprises phase-shifting the input (x[m]) thereby generating a phase-shifted input (\tilde{x}[m]), and precoding the phase-shifted input utilizing DFT, thereby generating M Fourier coefficients (X[k]). The method further comprises ordering the Fourier coefficients and selecting M/2 Fourier coefficients and generating the DFT-s-OFDM signal based on the M/2 selected Fourier coefficients.

The method achieves all the advantages and technical effects of the signal transmission apparatus.

It is to be appreciated that all the aforementioned implementation forms can be combined.

It has to be noted that all devices, elements, circuitry, units, and means described in the present application could be implemented in the software or hardware elements or any kind of combination thereof. All steps which are performed by the various entities described in the present application, as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a block diagram that illustrates various exemplary components of a signal transmission apparatus, in accordance with an embodiment of the present disclosure;

FIG. 1B is a network environment diagram that depicts communication between a transmitter and a receiver, in accordance with an embodiment of the present disclosure;

FIG. 1C is a block diagram that depicts various exemplary components of a signal transmission apparatus, in accordance with another embodiment of the present disclosure;

FIG. 2 depicts a graphical representation that illustrates block error rate (BLER) for different combinations of P and ƒ₁, in accordance with an embodiment of the present disclosure;

FIG. 3 depicts a graphical representation that illustrates a relation between block error rate (BLER) and signal-to-noise ratio (SNR), in accordance with an embodiment of the present disclosure;

FIG. 4 depicts a graphical representation that illustrates a relation between M modulation symbols and signal-to-noise ratio (SNR), in accordance with an embodiment of the present disclosure;

FIG. 5 depicts a graphical representation that illustrates a relation between peak-to-average-power-ratio (PAPR) and Complementary Cumulative Distribution Function (CCDF), in accordance with an embodiment of the present disclosure;

FIG. 6 depicts a graphical representation that illustrates a relation between block error rate (BLER) and signal-to-noise ratio (SNR), in accordance with an embodiment of the present disclosure; and

FIG. 7 is a flowchart of a method for use in a signal transmission apparatus, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

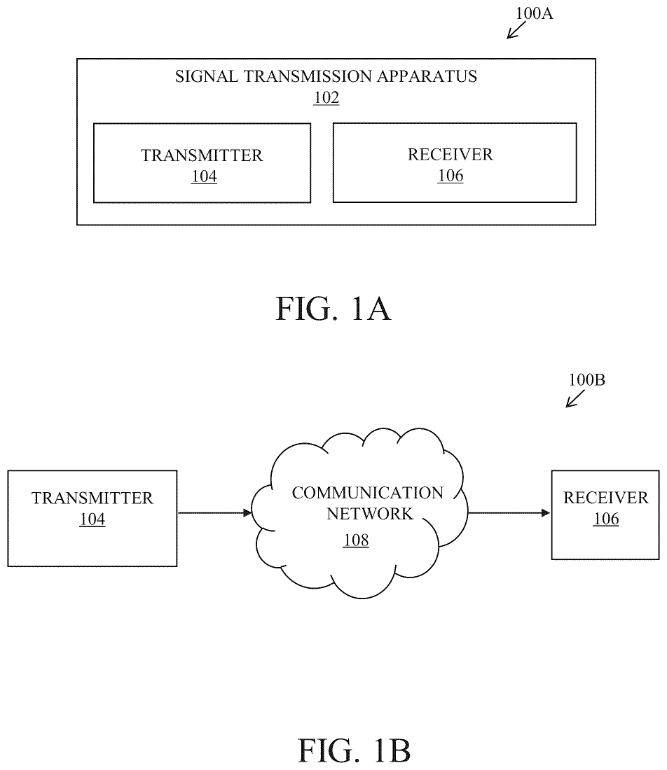

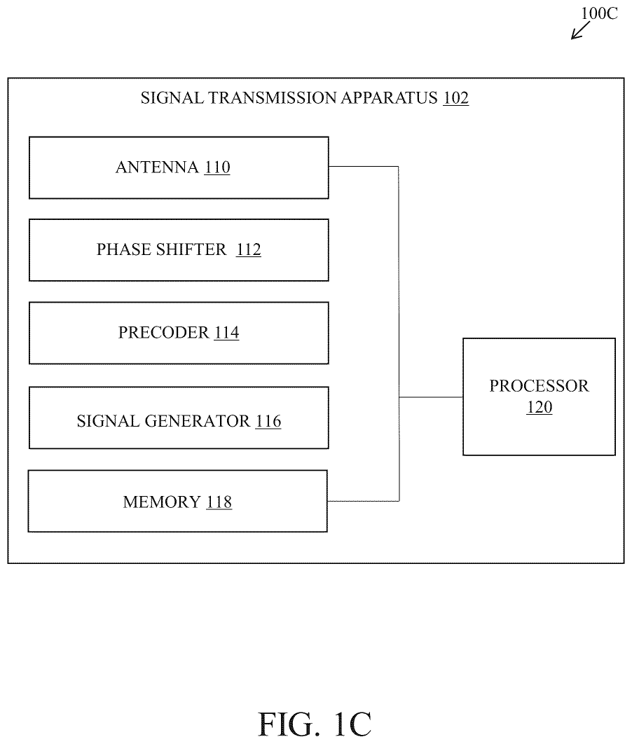

FIG. 1A is a block diagram that illustrates various exemplary components of a signal transmission apparatus, in accordance with an embodiment of the present disclosure. With reference to FIG. 1A, there is shown a block diagram 100A of a signal transmission apparatus 102 that includes a transmitter 104 and a receiver 106.

The signal transmission apparatus 102 may include suitable logic, circuitry, interfaces and/or code that is configured for communication of modulation symbols. Examples of the signal transmission apparatus 102 may include, but are not limited to, a transceiver, a base station, a user equipment, and the like. The signal transmission apparatus 102 may be used in applications, such as ultra-reliable low latency communication (URLLC), vehicle-to-everything (V2X) and the like.

The transmitter 104 may include suitable logic, circuitry, interfaces and/or code that is configured for transmission of modulation symbols to the receiver 106. Examples of the transmitter 104 may include but are not limited to, a machine type communication (MTC) device, a computing device, a transmitting device, an evolved universal mobile telecommunications system (UMTS) terrestrial radio access (E-UTRAN) NR-dual connectivity (EN-DC) device, a server, a customized hardware for wireless telecommunication, or any other portable or non-portable electronic device, and the like.

The receiver 106 may include suitable logic, circuitry, interfaces and/or code that is configured to receive modulation symbols transmitted by the transmitter 104. Examples of the receiver 106 may include, but are not limited to, a server, a smart phone, a customized hardware for wireless telecommunication, a receiving device, or any other portable or non-portable electronic device.

FIG. 1B is a network environment diagram that depicts communication between a transmitter and a receiver, in accordance with an embodiment of the present disclosure. FIG. 1B is described in conjunction with elements from FIG. 1A. With reference to FIG. 1B, there is shown a network environment diagram 100B that depicts communication between the transmitter 104 and the receiver 106. There is further shown a communication network 108.

In an implementation, the transmitter 104 is configured to transmit modulation symbols to the receiver 106 through the communication network 108 (e.g., a propagation channel). The communication network 108 includes a medium (e.g., a communication channel) through which the transmitter 104, potentially communicates with the receiver 106 of the signal transmission apparatus 102. Examples of the communication network 108 may include, but are not limited to, a cellular network (e.g., long-term evolution (LTE) 4G, a 5G, or 5G NR network, such as sub 6 GHz, cmWave, or mmWave communication network), a wireless sensor network (WSN), a cloud network, a Local Area Network (LAN), a vehicle-to-everything (V2X) network, a Metropolitan Area Network (MAN), and/or the Internet. The transmitter 104 in the network environment diagram 100B is configured to connect to the receiver 106, in accordance with various wireless communication protocols. Examples of such wireless communication protocols, communication standards, and technologies may include, but are not limited to, IEEE 802.11, 802.11p, 802.15, 802.16, 1609, Worldwide Interoperability for Microwave Access (Wi-MAX), Transmission Control Protocol and Internet Protocol (TCP/IP), User Datagram Protocol (UDP), Hypertext Transfer Protocol (HTTP), Long-term Evolution (LTE), File Transfer Protocol (FTP), Enhanced Data GSM Environment (EDGE), Voice over Internet Protocol (VoIP), a protocol for email, instant messaging, and/or Short Message Service (SMS), and/or other cellular or IoT communication protocols.

FIG. 1C is a block diagram that depicts various exemplary components of a signal transmission apparatus, in accordance with an embodiment of the present disclosure. FIG. 1C is described in conjunction with elements from FIGS. 1A and 1B. With reference to FIG. 1C, there is shown a block diagram 100C that depicts the signal transmission apparatus 102 comprising an antenna 110, a phase shifter 112, a precoder 114, a signal generator 116, a memory 118 and a processor 120. In an implementation, each of the antenna 110, the phase shifter 112, the precoder 114, the signal generator 116, the memory 118 and the processor 120 may be a part of the transmitter 104. In another implementation, each of the antenna 110, the phase shifter 112, the precoder 114, the signal generator 116, the memory 118 and the processor 120 are separate circuits or modules (and may not be a part of the transmitter 104).

The antenna 110 may include suitable logic, circuitry, interfaces and/or code that is configured for receiving an input (x[m]) comprising M modulation symbols. Examples of the antenna 110 may include, but are not limited to, a radio frequency transceiver, a network interface, a telematics unit, or any antenna suitable for use in a user equipment, a repeater, a base station or other portable or non-portable communication devices. The antenna 110 may wirelessly communicate by use of various wireless communication protocols.

The phase shifter 112 may include suitable logic, circuitry, interfaces and/or code that is configured for phase-shifting the input (x[m]) and thereby, generating a phase-shifted input (\acute{x}[m]).

The precoder 114 may include suitable logic, circuitry, interfaces and/or code that is configured for precoding the phase-shifted input (\acute{x}[m]) utilizing Discrete Fourier Transform (DFT), thereby generating M Fourier coefficients (X[k]). Examples of the precoder 114 may include but are not limited to, a DFT precoder, Discrete Cosine Transform, DCT precoder, and the like.

The signal generator 116 may include suitable logic, circuitry, interfaces and/or code that is configured for generating a DFT-spread-orthogonal frequency division multiplexing (DFT-s-OFDM) signal based on M/2 selected Fourier coefficients.

The memory 118 may include suitable logic, circuitry, interfaces and/or code that is configured to store machine code and/or instructions executable by the processor 120. The memory 118 may temporally store one or more DFT-s-OFDM signals, which are then transmitted by the transmitter 104 of the signal transmission apparatus 102. Examples of implementation of the memory 118 may include, but are not limited to, an Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory. The memory 118 may store an operating system and/or a computer program product to operate the signal transmission apparatus 102. A computer readable storage medium for providing a non-transient memory may include, but is not limited to, an electronic storage device, a magnetic storage device, an optical storage device, an electromagnetic storage device, a semiconductor storage device, or any suitable combination of the foregoing.

The processor 120 may include suitable logic, circuitry, interfaces and/or code that is configured to execute instructions stored in the memory 118. Examples of the processor 120 may include, but are not limited to an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the processor 120 may refer to one or more individual processors, processing devices, a processing unit that is part of a machine.

In operation, the signal transmission apparatus 102 is configured for transmission of modulation symbols utilizing orthogonal frequency-division multiplexing, OFDM, based on Discrete Fourier Transform, DFT, precoding. The signal transmission apparatus 102 is further configured to generate a DFT-s-OFDM signal by receiving an input (x[m]) comprising M modulation symbols for m=0, 1, . . . , M−1, where M is an even number. The modulation symbols are multiplexed in both time and frequency domain which provides diversity gains in time-frequency selective channels and in contrast to a conventional DFT-s-OFDM, where the modulation symbols are time multiplexed only. Furthermore, the modulation symbols are pre-coded using the DFT precoding. The generated DFT-s-OFDM signal has improved reliability in terms of improved block error rate (BLER) and PAPR with low spectral efficiency. The antenna 110 of the signal transmission apparatus 102 is configured to receive the input (x[m]).

In accordance with an embodiment, the input symbols (x[m]) are real-valued modulation symbols. The input symbols (x[m]) are real-valued modulation symbols and M is an even number.

The signal transmission apparatus 102 is further configured to generate the DFT-s-OFDM signal by phase-shifting the input (x[m]) thereby generating a phase-shifted input (\acute{x}[m]). The input (x[m]) is phase shifted by use of the phase shifter 112 in order to generate the phase-shifted input (\acute{x}[m]), represented by equation (1)

$${x}^{´} [ m ] = {e}^{j ( α {m}^{2} + β m + γ )} x [ m ] , m = 0 , 1 , … , M - 1 \qquad ( 1 )$$

The modulation symbols x[m] are real-valued.

In accordance with an embodiment, the phase-shift for modulation symbol m is obtained from the complex exponential function e^{j(αm}^{²}^{+βm+γ)} and the phase-shifted input (\acute{x}[m]) is determined by:

$${x}^{´} [ m ] = {e}^{j ( α {m}^{2} + β m + γ )} x [ m ] , m = 0 , 1 , … , M - 1$$

wherein α, β and γ are real-valued.

The phase-shifted input (\acute{x}[m]) is generated by considering the phase in form of the complex exponential function e^{j(αm}^{²}^{+βm+γ)} according to the equation (1). Moreover, the parameters α, β, and γ are real-valued parameters.

In accordance with an embodiment, the phase shifting function includes α=0. In an implementation, the complex exponential function e^{j(αm}^{²}^{+βm+γ)} for phase shifting the input (x[m]) includes α=0.

The signal transmission apparatus 102 is further configured to generate the DFT-s-OFDM signal by precoding the phase-shifted input utilizing DFT, thereby generating M Fourier coefficients (X[k]). The phase-shifted input (\acute{x}[m]) is precoded by use of the precoder 114, for example, DFT precoder, in order to generate the M Fourier coefficients (X[k]). The generation of the M Fourier coefficients (X[k]) is represented by equation (2)

$$X [ k ] = \frac{1}{\sqrt{M}} {\sum }_{m = 0}^{M - 1} {x}^{´} [ m ] {e}^{- j \frac{2 π}{M} mk} , k = 0 , 1 , … , M - 1 \qquad ( 2 )$$

The signal transmission apparatus 102 is further configured to generate the DFT-s-OFDM signal by ordering the Fourier coefficients and selecting M/2 Fourier coefficients. Due to only using M/2 Fourier coefficients, it is referred to as SSB transmission. The generated M Fourier coefficients (X[k]) are ordered and M/2 Fourier coefficients are selected.

In accordance with an embodiment, the signal transmission apparatus 102 being characterized in that the time-discrete low-pass equivalent signal is generated by:

$$s [ n ] = \frac{1}{\sqrt{N}} {\sum }_{k = 0}^{M / 2 - 1} X [ g [ k ] ] {e}^{j \frac{2 π}{N} nq [ k ]} , n = 0 , 1 , … , N - 1 \qquad ( 3 )$$

wherein N denotes the number of time samples, the q[k] is a function which maps Fourier coefficients to subcarriers, and wherein g[k] is a function for selecting and ordering the Fourier coefficients. The DFT-s-OFDM signal generated based on the selected M/2 Fourier coefficients is represented by equation (3). Since M is considered even and L=M/2, this gives the maximum improvement of spectral efficiency compared to conventional DFT-s-OFDM with L=M. Moreover, the selection of Fourier coefficients is made by the function g[k], which cannot be chosen arbitrarily. The reason being the function g[k] together with the phase modulation function should provide orthogonal signalling. It can be mathematically proven that the particular disclosed general function g[k] makes it possible to select M/2 Fourier coefficients, together with specifically associated phase values α, β, and γ, such that orthogonal signalling is achieved. In aforementioned implementation, the time-discrete signal s[n] is used. In another implementation, a lowpass equivalent time-continuous signal may be defined as s(t)=Σₖ₌₀^{N-1} X[g[k]]e^{j2π\tilde{ƒ}}^{ₖ}^{t} for 0≤t≤T where \tilde{ƒ}ₖ is a subcarrier frequency. The lowpass equivalent time-continuous signal may be defined for −T_{CP}≤t<T to include a cyclic prefix (CP) of length T_{CP}.

The signal transmission apparatus 102 is further configured to generate the DFT-s-OFDM signal based on the M/2 selected Fourier coefficients. The DFT-s-OFDM signal is generated by use of the signal generator 116 based on the M/2 selected Fourier coefficients. With a CP, the generated DFT-s-OFDM signal whose time-discrete representation for sample n=−N_{CP}, −N_{CP}+1, . . . , N−1 is represented by equation (4)

$${s}^{´} [ n ] = s [ n ( mod N ) ] , n = - {N}_{CP} , - {N}_{CP} + 1 , … , N - 1 \qquad ( 4 )$$

In accordance with an embodiment, the generated DFT-s-OFDM signal additionally comprises a cyclic prefix. The generated DFT-s-OFDM represented by the equation (4) comprises the cyclic prefix (CP) and the number of samples for the CP is N_{CP}.

In accordance with an embodiment, the mapping q[k] is to a set of contiguous sub carriers. In an implementation, the mapping of the 0 to (M/2−1) Fourier coefficients can be a set of contiguous N subcarriers. The one-to-one function q[k] maps M/2 Fourier coefficients (X[k]) to a subset of N subcarriers. Several types of mapping functions can be used, e.g., contiguous mapping (q[k]=k+d), comb mapping (q[k]=pk+d) where p and d are integers, or any other form of interleaved mapping or non-contiguous mapping.

In accordance with an embodiment, the mapping q[k] is to a set of non-contiguous subcarriers. In an implementation, the mapping of the 0 to (M/2−1) Fourier coefficients can be a set of non-contiguous N subcarriers. A non-contiguous mapping may render higher frequency diversity than for the continuous mapping, while resulting in higher PAPR of the signal.

In accordance with an embodiment, the g[k] function is defined as:

$$g [ k ] = f [ h [ k ] ] \qquad ( 5 )$$

$$with the function$$

$$f [ i ] = {f}_{1} i + {f}_{0} ( mod M ) \qquad ( 6 )$$

$$and the function$$

$$h [ k ] = k + M / P ⌊ k / ( M / P ) ⌋ \qquad ( 7 )$$

wherein M/P and P are integers and also the coefficients ƒ₁ and ƒ₀ are integers, for which the greatest common divisor of ƒ₁ and M is 1, and k=0, 1, . . . , M/2−1, and (mod M) denotes addition modulo M and └.┘ denotes the floor function. The function according to equation (5) extracts M/2 out of the M Fourier coefficients in a block-wise manner where M/P (M/2P) determines the number of contiguous indices of a block when P is an integer which is even (odd). That is M/P should be an integer and P is the number of blocks. According to the equation (6), the ƒ₁ and ƒ₀ are integers where ƒ₀ determines a starting index offset. The ƒ₁ coefficient should be chosen such that the indices produced by ƒ[i] are unique. This is achieved if the greatest common divisor of ƒ₁ and M is 1 (gcd(ƒ₁, M)=1), where gcd(A, B) is the greatest common divisor of A and B.

In accordance with an embodiment, the g[k] function is configured to provide consecutive indices from 0 to (M/2−1). The function according to equation (5) extracts M/2 out of the M Fourier coefficients in a block-wise manner where M/P (M/2P) determines the number of contiguous indices of a block when P is an integer which is even (odd).

In accordance with an embodiment, the g[k] function is configured to provide non-consecutive indices. In an implementation, the g[k] function selects the non-consecutive indices.

In accordance with an embodiment, P is set to 1 and ƒ₁ is set to 2. In an implementation, when P is set to 1 and ƒ₁ is set to 2, which creates a comb.

In accordance with an embodiment, P is set to M and ƒ₁ is set as the smallest integer larger than 1 such that the greatest common divisor of ƒ₁ and M is 1. In an implementation, if P is set to M then, ƒ₁ is set as the smallest integer larger than 1 such that the greatest common divisor of ƒ₁ and M is 1 or gcd(ƒ₁, M)=1.

In accordance with an embodiment, the function ƒ[i] is arranged to produce other indices than the corresponding h[k]. It should be noted that ƒ[i] does not necessarily re-order the selected indices h[k] but could produce other indices than its input. That is, for the set of integers [symbol] ={h[k]: k=0, 1, . . . , M/2−1} and [symbol] ={g[k]: k=0, 1, . . . , M/2−1}, it is possible that [symbol] ≠ [symbol] .

In an exemplary scenario, let h={h[k]} and g={g[k]}denote the sequence of integers and consider the following examples for M=30. Since M=2·3·5, it follows that P∈{1, 2, 3, 5, 6, 10, 15, 30} and ƒ₁ can be 2 when P=1 or can be any integer whose prime decomposition does not include P. The following computation shows how the indices are obtained.

Selection of the M/2 first Fourier coefficients:

$$P = 1 , {f}_{1} = 1 and {f}_{0} = 0$$

$$h = \{ 0 , 1 , 2 , \text{…} , 14 \}$$

$$g = \{ 0 , 1 , 2 , … , 14 \}$$

Selection of M/2 contiguous Fourier coefficients:

$$P = 1 , {f}_{1} = 1 and {f}_{0} \neq 0$$

$$h = \{ 0 , 1 , 2 , … , 14 \}$$

$$g = \{ {f}_{0} , {f}_{0} + 1 , {f}_{0} + 2 , … , {f}_{0} + 29 \} ( mod 30 )$$

Selection of every other Fourier coefficient:

$$P = 1 , {f}_{1} = 2 and {f}_{0} \neq 0$$

$$h = \{ 0 , 1 , 2 , … , 14 \}$$

$$g = \{ {f}_{0} , {f}_{0} + 2 , {f}_{0} + 4 , … , {f}_{0} + 28 \} ( mod 30 )$$

$$P = 30 , {f}_{1} = 1 and {f}_{0} \neq 0$$

$$h = \{ 0 , 2 , 4 , … , 28 \}$$

$$g = \{ {f}_{0} , {f}_{0} + 2 , {f}_{0} + 4 , … , {f}_{0} + 58 \} ( mod 30 )$$

Selection based on one block of Fourier coefficients:

$$P = 1 , {f}_{1} = 7 and {f}_{0} = 0$$

$$h = \{ 0 , 1 , 2 , … , 14 \}$$

$$g = \{ 0 , 7 , 14 , 21 , 28 , 5 , 12 , 19 , 26 , 3 , 10 , 17 , 24 , 1 , 8 \}$$

Selection based on multiple blocks of Fourier coefficients:

$$P = 3 , {f}_{1} = 1 and {f}_{0} = 0$$

$$h = \{ 0 , 1 , 2 , … , 9 , 20 , 21 , … , 24 \}$$

The first block contains M/P=10 indices, and the last block M/2P=5 indices.

$$g = \{ 0 , 1 , 2 , 3 , 4 , 5 , 6 , 7 , 8 , 9 , 20 , 21 , 22 , 23 , 24 \}$$

$$P = 5 , \qquad {f}_{1} = 1 \qquad and \qquad {f}_{0} = 0$$

$$h = \{ 0 , 1 , … , 5 , 12 , 13 , … , 17 , 24 , 25 , 26 \}$$

The first two blocks contain M/P=6 indices, and the last block M/2P=3 indices.

$$g = \{ 0 , 1 , 2 , 3 , 4 , 5 , 12 , 13 , 14 , 15 , 16 , 17 , 24 , 25 , 26 \}$$

$$P = 3 , \qquad {f}_{1} = 7 \qquad and \qquad {f}_{0} = 0$$

$$h = \{ 0 , 1 , 2 , … , 9 , 20 , 21 , … , 24 \}$$

$$g = \{ 0 , 7 , 14 , 21 , 28 , 5 , 12 , 19 , 26 , 3 , 20 , 27 , 4 , 11 , 18 \}$$

$$P = 5 , \qquad {f}_{1} = 7 \qquad and \qquad {f}_{0} = 0$$

$$h = \{ 0 , 1 , … , 5 , 12 , 13 , … , 17 , 24 , 25 , 26 \}$$

$$g = \{ 0 , 7 , 14 , 21 , 28 , 5 , 24 , 1 , 8 , 15 , 22 , 29 , 18 , 25 , 2 \}$$

The advantage of using the equation (5), the equation (6) and the equation (7) is that the function g[k] offers high flexibility by means of its parameterization in P, ƒ₁ and ƒ₀ and that it has the analytical tractability required for proving orthogonal transmission. Moreover, the introduction of ƒ₁ and ƒ₀ also makes it possible to utilize complex valued modulation symbols.

In accordance with an embodiment, parameters of the function g[k] are determined to provide orthogonal signalling, by fulfilling:

$$C \cdot Re \{ {\sum }_{n = 0}^{M - 1} w [ m , n ] {w}^{*} [ p , n ] \} = δ [ m - p ]$$

where C is a constant, δ[t] is the Kronecker delta function for an integer t, Re{ } is the real-part operator and * denotes complex conjugate, wherein w[m, n] is defined for m=0, 1, . . . , M−1 and n=0, 1, . . . , N−1 as:

$$w [ m , n ] = \frac{1}{M} {\sum }_{k = 0}^{M / 2 - 1} {e}^{j ( α {m}^{2} + β m + γ )} {e}^{- j \frac{2 π}{M} g [ k ] m} {e}^{j \frac{2 π}{M} q [ k ] n}$$

The specific values of the parameters α, β and γ result in orthogonal signalling together with the functions of the equation (5). To find such values, it is realized that the signal of the equation (3) with N=M, can be expressed in form of the equation (8)

$$s [ n ] = {\sum }_{m = 0}^{M - 1} x [ m ] {\underbrace{\frac{1}{M} {\sum }_{k = 0}^{M / 2 - 1} {e}^{j ( α {m}^{2} + β m + γ )} {e}^{- j \frac{2 π}{M} g [ k ] m} {e}^{j \frac{2 π}{M} q [ k ] n}}}_{w [ m , n ]} \qquad ( 8 )$$

where, where w[m, n] is referred to as a basis function. A key point is that since, the input x[m] are real-valued modulation symbols, the orthogonal signalling is obtained if the complex-valued basis functions are orthogonal in the real-part domain, i.e., for 0≤p≤M−1 and 0≤m≤M−1 according to equation (9)

$$C \cdot Re \{ {\sum }_{n = 0}^{M - 1} w [ m , n ] {w}^{*} [ p , n ] \} = δ [ m - p ] \qquad ( 9 )$$

where, δ[m−p] is the Kronecker delta function. If the basis functions are orthogonal in the real-part domain, a receiver (e.g., the receiver 106) can detect the modulation symbols by correlating the received signal with the set of basis functions and extracting the corresponding real values. The equation (9) is equivalent to the following condition of equation (10)

$$C \cdot Re \{ \frac{1}{M} {\sum }_{k = 0}^{M / 2 - 1} {e}^{j ( α ( m - p ) ( p + m ) + β ( m - p ) )} {e}^{- j \frac{2 π}{M} {f}_{0} ( m - p )} {e}^{- j \frac{2 π}{M} ( {f}_{1} ( k + \frac{M}{P} ⌊ \frac{k}{M / P} ⌋ ) ) ( m - p )} \} = δ [ m - p ] \qquad ( 10 )$$

The orthogonality is not dependent on the function q[k] or the parameter γ and the present disclosure does not put any restrictions on those. The equation (10) has multiple solutions of pairs (α, β) for given parameters M, P, ƒ₁ and ƒ₀. If α=0, it is referred to as a linear phase and if α≠0, it is referred to as a chirp phase. The solutions to the equation (10) can, e.g., be found by numerical search and typically α and β are in multiples of π/M.

It can be shown that for conventional DFT-s-OFDM, where all M DFT coefficients are used and where there is no re-ordering of the DFT coefficients, the basis function becomes w[m, n]=δ[n−m]. That implies that modulation symbol x[m] is transmitted on time sample n=m, i.e., the modulation symbols are time-multiplexed. This is in contrast to (8), wherein the effect of the new basis function is that the modulation symbols become multiplexed both in time- and frequency domain.

In an exemplary scenario, if M=P=24 and ƒ₁=7 and ƒ₀=0, it can be found through search that

$$α = 8 {t}_{0} \frac{π}{24} , {t}_{0} = 0 , 1 , … , 48 and β = ( 1 + 2 {t}_{1} ) \frac{π}{24} , {t}_{1} = 1 , … , 23$$

are solutions of pairs that fulfil the equation (10) for all combinations of t₀ and ti.

Moreover, the closed-form solutions for some cases are derived and contained in a Table 1. However, these are not only the solutions for given parameters M, P, ƒ₁ and ƒ₀.

TABLE 1
Phase values for associated parameters

| Parameter | Linear phase (α = 0) | Chirp phase (α + 0) |
|---|---|---|
| P is even | $β = π {f}_{1} - \frac{π}{M} {f}_{1} + \frac{2 π}{M} {f}_{0}$ | $β = \frac{3}{2} π {f}_{1} − \frac{π}{P} {f}_{1} − 2 \frac{π}{M} {f}_{1} + \frac{2 π}{M} {f}_{0}$ $and$ $α = \frac{π}{P} {f}_{1}$ |
| P = 1 | $β = π {f}_{1} - \frac{π}{M} {f}_{1} + \frac{2 π}{M} {f}_{0} , and {f}_{1} \neq 2$ $β = π - \frac{π}{M} + \frac{2 π}{M} {f}_{0} , and {f}_{1} = 2$ | $β = \frac{2 π}{M} {f}_{0} + \frac{π}{2} {f}_{1} - \frac{π}{M} {f}_{1} and α = \frac{π}{2} {f}_{1}$ |

It can be verified from numerical examples that the M Fourier coefficients X[k] are comprised of M/2 complex-conjugated pairs and the function g[k] of the equation (5) selects one Fourier coefficient of each pair. No information is lost by transmitting only one coefficient of a pair, since the only difference among a complex-conjugated pair of Fourier coefficients is the sign of the complex-valued part. Therefore, the M modulation symbols x[m] could be signalled by using only M/2 Fourier coefficients. However, the order relation among the complex-conjugated pairs of Fourier coefficients for the disclosed solution depends on the values α, β and P. The values of the Fourier coefficients also differ for different values of α, β and P.

In accordance with an embodiment, the input symbols (x[m]) are based on a π/2-rotated Pulse Amplitude Modulation, PAM, scheme, wherein a=0, β=π/2, P=1 and ƒ₁=1, with ƒ₀=(M+2)/4. Typically, only real-valued modulation symbols (e.g., BPSK) can be used with conventional SSB transmission, which excludes modulation formats, such as π/2-BPSK. An advantage of using the function (5) is that such a restriction would be alleviated if P, ƒ₁ and ƒ₀ can be selected in such a way that the orthogonal signalling is achieved, when α=0 and β=π/2. That means, α and β are predefined. In contrast to the conventional SSB transmission, where the phase angle cannot be chosen arbitrarily, the signal transmission apparatus 102 is configured to use the PAM (i.e., including BPSK) constellation which is rotated by π/2 radians between consecutive symbols. By virtue of using the π/2-rotated PAM, there is a particular symmetry in the Fourier coefficients when the phase shift of π/2 radians is applied. Suppose that k=0, 1, . . . , M/2, then for the PAM modulated signal with 7c/2 phase rotation, the Fourier coefficients are symmetric according to an equation (11), and equation (12)

$$\begin{matrix}X [ M / 2 - k ] = \frac{1}{\sqrt{M}} {\sum }_{m = 0}^{M - 1} {e}^{j \frac{π}{2} m} x [ m ] {e}^{- j \frac{2 π}{M} m ( \frac{M}{2} - k )} \\ = \frac{1}{\sqrt{M}} {\sum }_{m = 0}^{M - 1} {e}^{- j \frac{π}{2} m} x [ m ] {e}^{j \frac{2 π}{M} m k} \\ = {X}^{*} [ k ]\end{matrix} \qquad ( 11 )$$

Furthermore, it is supposed that k=1, 2, . . . , M/2−1, then:

$$\begin{matrix}X [ M / 2 + k ] = \frac{1}{\sqrt{M}} {\sum }_{m = 0}^{M - 1} {e}^{j \frac{π}{2} m} x [ m ] {e}^{- j \frac{2 π}{M} m ( \frac{M}{2} + k )} \\ = \frac{1}{\sqrt{M}} {\sum }_{m = 0}^{M - 1} {e}^{j \frac{π}{2} m} {e}^{- j π m} x [ m ] {e}^{- j \frac{2 π}{M} m k} \\ = \frac{1}{\sqrt{M}} {\sum }_{m = 0}^{M - 1} {e}^{- j \frac{π}{2} m} x [ m ] {e}^{j \frac{2 π}{M} m ( M - k )} \\ = {X}^{*} [ M - k ]\end{matrix} \qquad ( 12 )$$

By using the equations (11) and (12), it can be found that if M is an even integer not divisible by 4, there are M Fourier coefficients which each has a complex-conjugate pair. This suggests that it will be possible to select L=M/2 Fourier coefficients i.e., one from each complex-conjugate pair. Likewise, if M is an even integer divisible by 4, there are M−2 coefficients which each has a complex-conjugate pair. This suggests that it will be possible to select L=(M−2)/2+2=M/2+1 Fourier coefficients, i.e., one from each complex-conjugate pair and the two remaining Fourier coefficients.

Focusing on the case with L=M/2, the π/2 rotated PAM is achieved by setting α=0, β=π/2, P=1 and ƒ₁=1. By evaluating the equation (10), it can be confirmed that the orthogonal signalling for this parameter combination is obtained if ƒ₀=(M+2)/4. Since it is required that M is an even integer not divisible by 4, ƒ₀ becomes an integer. Furthermore, it is noted that symmetries can be obtained with further generalizations, e.g., if the equation (1) is generalized using γ=π/2 according to equation (13)

$${x}^{´} [ m ] = {e}^{j \frac{π}{2} ( m + 1 )} x [ m ] , m = 0 , 1 , … , M - 1 \qquad ( 13 )$$

$$then :$$

$$X [ M / 2 - k ] = - {X}^{*} [ k ] \qquad ( 14 )$$

$$X [ M / 2 + k ] = - {X}^{*} [ M - k ] \qquad ( 15 )$$

Moreover, there exists an alternative signal representation (or an equivalent matrix representation) for the DFT-s-OFDM signal represented by the equations (1), (2), and (3). The equivalent matrix representation includes the following notations, where [.]′ and [.] ^{H} denote transpose and Hermitian transpose, respectively, and diag[⋅] is a diagonal matrix:
DFT matrix: W_{M}=[wₖₗ] with

$${w}_{kl} = \frac{1}{\sqrt{M}} {e}^{- j \frac{2 π}{M} kl}$$

for k=0, 1, . . . , M−1 and l=0, 1, . . . , M−1
Phase matrix: R=diag[e^{j(αm}^{²}^{+βm+γ)}] for m=0, 1, . . . , M−1
Selection matrix: G=[gₖₗ] with gₖₗ∈{0, 1} for k=0, 1, . . . , M/2−1 and l=0, 1, . . . , M−1
Mapping matrix: Q=[qₖₗ] with qₖₗ∈{0, 1} for k=0, 1, . . . , N−1 and 1=0, 1, . . . , M/2−1
Symbol vector: x=[x[m]]′ for m=0, 1, . . . , M−1
Signal vector: s=[s[n]]′ for n=0, 1, . . . , N−1

For the selection matrix, there are M/2 elements for which gₖₗ=1 and there is at most one element for which gₖₗ=1 per row and column. The positions of the ones are determined from g[k] such that the kth row contains a one in column g[k].

For the mapping matrix, there are M/2 elements for which qₖₗ=1 and there is at most one element for which qₖₗ=1 per row and column. The positions of the ones are determined from q[k] such that the kth row contains a one in column q[k].

The transmitted signal (i.e., the DFT-s-OFDM signal) can then be written in form of an equation (16):

$$s = {W}_{N}^{H} Q G {W}_{M} R x \qquad ( 16 )$$

The basis functions as defined by the equation (8) are the columns of the matrix w=W_{N}^{H}QGW_{M}R, thus 2 Re{w^{H}w}=I, where I is the identity matrix. Moreover, by considering the case with N=M, then by defining the precoding matrix according to an equation (17)

$$P = {W}_{M}^{H} Q G {W}_{M} R \qquad ( 17 )$$

an equivalent operation is to perform precoding with P prior to the precoder 114, which can be seen from an equation (18):

$$s = {W}_{M}^{H} {W}_{M} P x \qquad ( 18 )$$

Hence, the transmitter 104 of the signal transmission apparatus 102 can alternatively be implemented as a DFT-s-OFDM technique, where its input (i.e., the input (x[m])) is precoded according to the equation (17).

In accordance with an embodiment, the input symbols (x[m]) are based on a Zadoff-Chu sequence. In an implementation, where the input symbols (x[m]) are based on the Zadoff-Chu sequence, the DFT-s-OFDM signal transmission may also be referred to as a chirp sequence transmission. In a case, when the input symbols x[m]=1, the input to the precoder 114 (e.g., the DFT precoder) is a chirp sequence, \acute{x}[m]=e^{j(αm}^{²}^{+βm+γ)}. The chirp sequence may also be referred to as a predetermined reference-or synchronization signal sequence. Alternatively, if there would be a set of distinct such sequences, information could be conveyed by the selection of the sequence (i.e., the sequence is the codeword), and the receiver (e.g., the receiver 106) detects the selected sequence. In all cases, if the phase values are selected according to the equation (10), the orthogonal transmission is achieved. However, the SSB transmission can also be applied for other phase values. The following property represented by equations (19) and (20) can be mathematically proven and shows that there is symmetry in the Fourier coefficients under certain conditions.

Property 1. If there is a sequence, y[m], which fulfils an equation (19)

$$y [ m ] = y [ M - m ] \qquad ( 19 )$$

$$then , its Fourier coefficients fulfil :$$

$$Y [ k ] = Y [ M - k ] \qquad ( 20 )$$

A case is considered with α=πu/M, β=0, γ=0. When gcd (u, M)=1,

$$y [ m ] = {e}^{- j \frac{π u}{M} {m}^{2}}$$

is known as the Zadoff-Chu sequence and it is straightforward to verify that the Zadoff-Chu sequence fulfils the equation (19). And, the inverse u⁻¹ of u is defined according to equation (21)

$${u}^{- 1} u ( mod M ) ≡ 1 \qquad ( 21 )$$

and it can be shown that if gcd (u, M)=1, then there exists a unique integer u⁻¹<M fulfilling the equation (21). It follows that the DFT has the following property:

$$\begin{matrix}Y [ \frac{M}{2} ] = \frac{1}{\sqrt{M}} {\sum }_{m = 0}^{M - 1} {e}^{j \frac{π u}{M} {m}^{2}} {e}^{- j \frac{2 π M}{M 2} m} \\ = \frac{1}{\sqrt{M}} {\sum }_{m = 0}^{M - 1} {e}^{j \frac{π u}{M} {m}^{2}} {e}^{- j \frac{π u}{M} {Mu}^{- 1} m} \\ = \frac{1}{\sqrt{M}} {\sum }_{m = 0}^{M - 1} {e}^{j \frac{π u}{M} {( m - \frac{{Mu}^{- 1}}{2} )}^{2}} {e}^{- j \frac{π u}{M} {( \frac{{Mu}^{- 1}}{2} )}^{2}} \\ = \frac{{e}^{- j \frac{π}{4} {Mu ( {u}^{- 1} )}^{2}}}{\sqrt{M}} {\sum }_{m = 0}^{M - 1} {e}^{j \frac{π u}{M} {( m - \frac{{Mu}^{- 1}}{2} )}^{2}} \\ = {e}^{- j \frac{π}{4} {Mu ( {u}^{- 1} )}^{2}} Y [ 0 ]\end{matrix} \qquad ( 22 )$$

Thus, the equations (21) and (22) imply that it would be possible to reconstruct the sequence y[m] from M/2 Fourier coefficients. The requirements on the coefficients P, ƒ₁ and ƒ₀ cannot be determined with the same approach as defined in the equation (10), since the sequence to be detected, y[m], is complex-valued. However, from the equation (20) it follows that if P, ƒ₁ and ƒ₀ are selected such that the set [symbol] has the property that if a is an integer where a∈ [symbol] and M−a∈ [symbol] , then M/2 Fourier coefficients are selected such that the sequence y[m] can be reconstructed. This condition assures that only one Fourier coefficient from each pair of symmetric coefficients according to the equation (20) is selected.

In an exemplary scenario, consider a case with P=1, ƒ₁=1 and ƒ₀=0. Let I_{M/2} be the M/2×M/2 identity matrix and let 0_{M/2} be the M/2×M/2 zero matrix. The M/2×M selection matrix is formed according to the equation (23)

$$G = ( \begin{matrix}{I}_{M / 2} & {0}_{M / 2}\end{matrix} ) \qquad ( 23 )$$

At the receiver (e.g., the receiver 106), the coefficients are duplicated according to the equations (20) and (22) by the following matrix, as depicted in the equation (24)

$$D = ( \begin{matrix}{I}_{M / 2} \\ {V}_{M / 2} {T}_{M / 2}\end{matrix} ) \qquad ( 24 )$$

where the matrix T_{M/2} is repeating Fourier coefficient k at frequency M−k for k=M/2, M/2+1, . . . M−1 according to the equation (20) as depicted the equation (25)

$${T}_{M / 2} = ( \begin{matrix}1 & 0 & 0 & 0 & … & 0 \\ 0 & 0 & 0 & 0 & 0 & 1 \\ ⋮ & ⋮ & ⋮ & 0 & 1 & 0 \\ 0 & 0 & 0 & ⋰ & 0 & 0 \\ 0 & 0 & 1 & 0 & … & 0 \\ 0 & 1 & 0 & 0 & … & 0\end{matrix} ) \qquad ( 25 )$$

and where Fourier coefficient M/2 is multiplied by the phase value according to the equation (22) by the following equation (26)

$${V}_{M / 2} = ( \begin{matrix}{e}^{- j \frac{π}{4} {Mu ( {u}^{- 1} )}^{2}} & 0 & … & 0 \\ 0 & 1 & 0 & ⋮ \\ ⋮ & 0 & ⋱ & 0 \\ 0 & … & 0 & 1\end{matrix} ) \qquad ( 26 )$$

It follows that by multiplying with the matrix V_{M/2} in the receiver (i.e., the receiver 106), the M Fourier coefficients of x are obtained from the M/2 selected and transmitted Fourier coefficients GW_{M}x, i.e., the obtained parameters are defined by the equation (27)

$${DGW}_{M} x = {W}_{M} x \qquad ( 27 )$$

$$As a further simplification ,$$

$$D = ( \begin{matrix}{I}_{M / 2} \\ {V}_{M / 2} {W}_{M / 2} {W}_{M / 2}\end{matrix} ) \qquad ( 28 )$$

$$since it can be shown that :$$

$${T}_{M / 2} = {W}_{M / 2} {W}_{M / 2} \qquad ( 29 )$$

Thus, the signal transmission apparatus 102 enables full use of SSB transmission with the DFT-s-OFDM, the reason being in the DFT-s-OFDM signal, the modulation symbols are multiplexed in both time and frequency domain. This is advantageous in terms of providing diversity gains in time-frequency selective channels. Moreover, the signal transmission apparatus 102 manifests improved BLER and PAPR by virtue of ordering and selection of the Fourier coefficients. In contrast to conventional DFT-s-OFDM with SSB transmission, the signal transmission apparatus 102 supports to use the SSB transmission with π/2 rotated PAM constellation (i.e., π/2-BPSK). The signal transmission apparatus 102 is configured to introduce the phase rotation (e.g., π/2) to the BPSK modulation such that the orthogonality condition defined by the equation (10) is fulfilled. The π/2-BPSK is applicable for physical uplink shared channel (PUSCH) in an LTE/NR system. Furthermore, the signal transmission apparatus 102 is configured to introduce the function g[k] for selection and ordering of the Fourier coefficients which is commensurate with the phase shift according to the orthogonality condition. The signal transmission apparatus 102 is configured to introduce signalling which supports SSB transmission with the DFT-s-OFDM. For example, a UE capability signalling informing a network if the UE supports the modulation format. Signalling from the network to the UE to use the modulation format. This may be an on/off signal or a more elaborated scheme, e.g., a new configurable modulation and coding scheme (MCS) table containing some entries with the new modulation format. Additionally, the signal transmission apparatus 102 is applicable to channels using DFT-s-OFDM, i.e., the PUSCH in the uplink of LTE and new radio (NR). In LTE, physical side-link control channel (PSCCH), physical side-link shared channel (PSSCH), physical side-link broadcast channel (PSBCH), and physical side-link discovery channel (PSDCH) also use DFT precoding. The aforementioned channels comprise the side-link, which is used for LTE V2V. Thereto, narrow band Internet-of-Things (NB-IoT) system uses DFT-s-OFDM for narrow band PUSCH (NPUSCH). Furthermore, the NR may be extended to operate in frequency bands higher than 71 GHz, which may be considered in Release-19 and onwards. Due to particular characteristics in such high frequency bands (e.g., phase noise, low efficiency of power amplifier etc.), OFDM may not be a proper waveform and it is suggested that to introduce the DFT-s-OFDM in the downlink channels. Thus, in upcoming NR releases, the SSB transmission with the DFT-s-OFDM may be potentially applicable to physical downlink shared channel (PDSCH) and/or physical downlink control channel (PDCCH).

Additionally, in an implementation, the receiver 106 can be implemented as a matched filter, that is correlating the received signal with the set of basis functions and extracting the real-parts. Alternatively, the receiver 106 may be configured to perform the inverse operations of the transmitter 104 of the signal transmission apparatus 102. For example, the transmitter 104 is configured to perform the DFT of the M modulation symbols and the receiver 106 is configured to correspondingly perform an inverse-DFT (IDFT) on the received M modulation symbols. The disclosed solution allows for efficient implementation for both the transmitter 104 and receiver 106 for the particular case where every other Fourier coefficient is selected (i.e., the cases P=1 and ƒ₁=2 or P=M and ƒ₁=1). Then, it suffices to compute a DFT of size M/2 (e.g., by a fast Fourier transform (FFT) algorithm) instead of size M. Suppose ƒ₁=2, then g[k]=2k and the following holds:

$$\begin{matrix}X [ 2 k ] = \frac{1}{\sqrt{M}} {\sum }_{m = 0}^{M - 1} {e}^{j ( α {m}^{2} + β m + γ )} x [ m ] {e}^{- j \frac{2 π}{M} m 2 k} \\ = \frac{1}{\sqrt{M}} {\sum }_{m = 0}^{M - 1} {e}^{j ( α {m}^{2} + β m + γ )} x [ m ] {e}^{- j \frac{2 π}{M / 2} mk} \\ = \frac{1}{\sqrt{M}} {\sum }_{m = 0}^{M / 2 - 1} {e}^{j ( α {m}^{2} + β m + γ )} x [ m ] {e}^{- j \frac{2 π}{M / 2} mk} + \\ \frac{1}{\sqrt{M}} {\sum }_{m = M / 2}^{M - 1} {e}^{j ( α {m}^{2} + β m + γ )} x [ m ] {e}^{- j \frac{2 π}{M / 2} mk} \\ = \frac{1}{\sqrt{M}} {\sum }_{m = 0}^{M / 2 - 1} ( {e}^{j ( α {m}^{2} + β m + γ )} x [ m ] + \\ {e}^{j ( {α ( m + \frac{M}{2} )}^{2} + β ( m + \frac{M}{2} ) + γ )} x [ m + \frac{M}{2} ] ) {e}^{- j \frac{2 π}{M / 2} mk}\end{matrix} \qquad ( 30 )$$

Similarly, it can be shown that:

$$\begin{matrix}X [ 2 k + 1 ] = \frac{1}{\sqrt{M}} {\sum }_{m = 0}^{M - 1} {e}^{j ( α {m}^{2} + β m + γ )} x [ m ] {e}^{- j \frac{2 π}{M} m ( 2 k + 1 )} \\ = \frac{1}{\sqrt{M}} {\sum }_{m = 0}^{M / 2 - 1} ( {e}^{j ( α {m}^{2} + β m + γ )} x [ m ] - \\ {e}^{j ( {α ( m + \frac{M}{2} )}^{2} + β ( m + \frac{M}{2} ) + γ )} x [ m + \frac{M}{2} ] ) {e}^{- j \frac{2 π m}{M}} {e}^{- j \frac{2 π}{M / 2} mk}\end{matrix} \qquad ( 31 )$$

Hence, the modulation symbols are first pre-processed according to the equations (30) and (31), and then the DFT of size M/2 is performed. Thus, it is not required to compute a DFT of size M and then select M/2 Fourier coefficients.

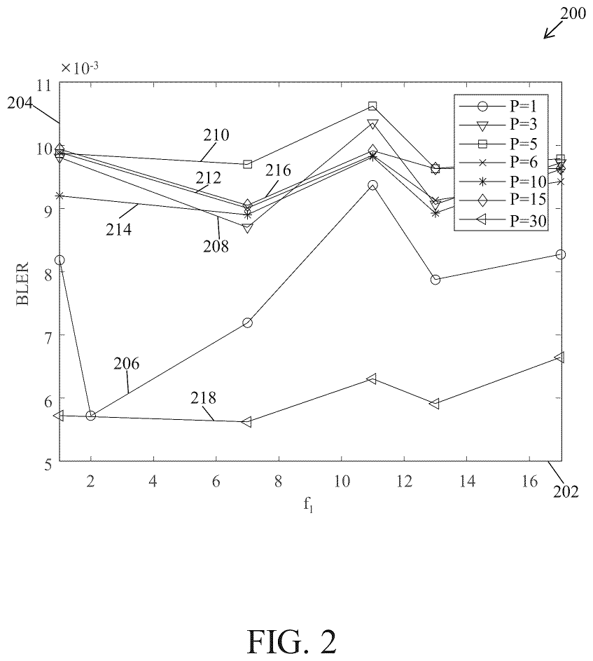

FIG. 2 depicts a graphical representation that illustrates block error rate (BLER) for different combinations of P and ƒ₁, in accordance with an embodiment of the present disclosure. FIG. 2 is described in conjunction with elements from FIGS. 1A, 1B, and 1C. With reference to FIG. 2, there is shown a graphical representation 200, which includes a X-axis 202 that illustrates a coefficient ƒ₁ that ranges from 1 to 16 and a Y-axis 204 that illustrates the value of BLER ranging from 5×10⁻³ to 11×10⁻³.

The BLER is evaluated on a time-frequency selective channel where a power delay profile follows the international telecommunication union (ITU) Vehicular A model and the velocity is set to 0 Km/h or 500 Km/h, as shown in a Table 2. With a subcarrier spacing of 15 kHz and at a carrier frequency of 6 GHz, 500 km/h corresponds to a maximum Doppler shift of 2.78 kHz, i.e., 19% of the subcarrier spacing. The number of symbols M is chosen as a multiple of 12, which is the number of sub-carriers per resource block in LTE and NR, e.g., for DFT-s-OFDM with SSB transmission, M=24 symbols are transmitted on one resource block with L=24/2=12 subcarriers. The Fourier coefficients are mapped contiguously to the subcarriers, i.e., q[k]=k.

TABLE 2
Evaluation Parameters for BLER simulations

| Parameter | Setting |
|---|---|
| Number of symbols | M = 24, 48, 72, 96, 120 |
| Channel | Vehicular A, 0 km/h, 500 km/h |
| Subcarrier spacing | 15 kHz |
| Carrier frequency | 6 GHz |
| Receiver | MMSE |
| Channel code | 3GPP Polar, code rates 1/3, 1/2, 2/3, 3/4 |
| Channel estimation | Ideal |

With reference to the graphical representation 200, a first line 206, a second line 208, a third line 210, a fourth line 212, a fifth line 214, a sixth line 216, and a seventh line 218 collectively illustrate the BLER at a signal-to-noise ratio (SNR) of 12 decibels (dB) for M=30 modulation symbols for different combinations of P and ƒ₁. For example, the first line 206 illustrates the BLER for P=1, the second line 208 illustrates the BLER for P=3, and the third line 210 illustrates the BLER for P=5 with different values of ƒ₁. Similarly, the fourth line 212 illustrates the BLER for P=6, the fifth line 214 illustrates the BLER for P=10, the sixth line 216 illustrates the BLER for P=15, and the seventh line 218 illustrates the BLER P=30 for different values of ƒ₁ within the range from 1 to 16. In an implementation, the combination of P, ƒ₁ and ƒ₀ can be selected to minimize the BLER. In the sequel ƒ₀=0, because its value does not have a large impact on the BLER. Moreover, the FIG. 2 illustrates the BLER at a fixed value of the SNR (e.g., 12 dB) for M=30, showing that there is a dependence on the BLER from the parameters P and ƒ₁. Thus, in the evaluations P=M and ƒ₁ is set as the smallest integer larger than 1 such that the greatest common divisor of ƒ₁ and M is 1 (i.e., gcd (ƒ₁, M)=1) to provide gain for all of the M modulation symbols.

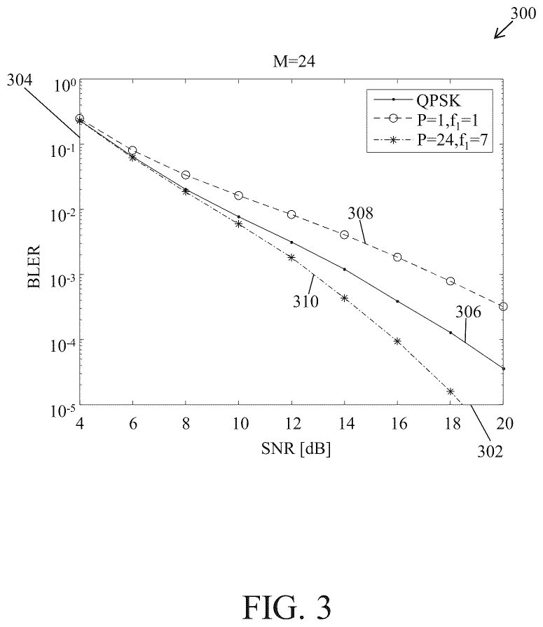

FIG. 3 depicts a graphical representation that illustrates a relation between block error rate (BLER) and signal-to-noise ratio (SNR), in accordance with an embodiment of the present disclosure. FIG. 3 is described in conjunction with elements from FIGS. 1A, 1B, and 1C. With reference to FIG. 3, there is shown a graphical representation 300, which includes a X-axis 302 that illustrates the SNR ranging from 4 dB to 20 dB and a Y-axis 304 that illustrates the value of BLER ranges from 10⁻⁵ to 10⁰.

The graphical representation 300 shows a comparison between the conventional QPSK (e.g., using M/2 modulation symbols), the BPSK rotated scheme (i.e., P=1 and ƒ₁=1), and the BPSK with the disclosed method with the P=24, and ƒ₁=7 that transmit the same number of bits and transmit on M/2 subcarriers, and thus have the same spectral efficiency and coding gain. With reference to the graphical representation 300, a first line 306, a second line 308, and a third line 310 collectively illustrate the relation between the BLER and the SNR on a vehicular A channel at 500 km/h. For example, the first line 306 illustrates the relation between the BLER and the SNR for the conventional QPSK. Similarly, the second line 308 illustrates the relation between the BLER and the SNR for the conventional BPSK rotated scheme with P=1, ƒ₁=1. Moreover, the third line 310 illustrates the relation between the BLER and the SNR for the proposed BPSK with P=24 (i.e., P=M), ƒ₁=7, in accordance with an embodiment. In the graphical representation 300, the M=24 modulation symbols are considered. Beneficially, in comparison to the conventional QPSK and the BPSK rotated scheme with P=1, ƒ₁=1, the disclosed BPSK with P=24 (i.e., P=M), ƒ₁=7 outperforms with the BLER lower than 10%. Similar results are obtained for other values of M modulation symbols (e.g., for P=M), such as for M=48, 72, 96, 120.

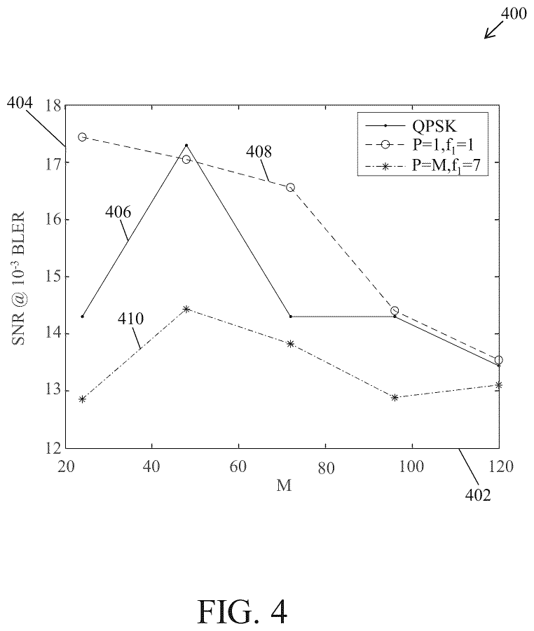

FIG. 4 depicts a graphical representation that illustrates a relation between M modulation symbols and signal-to-noise ratio (SNR), in accordance with an embodiment of the present disclosure. FIG. 4 is described in conjunction with elements from FIGS. 1A, 1B, and 1C. With reference to FIG. 4, there is shown a graphical representation 400, that includes a X-axis 402, representing M modulation symbols ranging from 20 to 120 and a Y-axis 404 that illustrates values of SNR ranging from 12 dB to 18 dB.

With reference to the graphical representation 400, a first line 406, a second line 408, and a third line 410 illustrate the relation between the M modulation symbols and required SNR for a BLER of 10⁻³ on a Vehicular A channel at 500 km/h. For example, the first line 406 illustrates the relation between the M modulation symbols and the required SNR for the conventional QPSK. Similarly, the second line 408 illustrates the relation between the M modulation symbols and the required SNR for the conventional BPSK with P=1, ƒ₁=1. Moreover, the third line 410 illustrates the relation between the M modulation symbols and the required SNR for the disclosed BPSK with P=M and ƒ₁=7, in accordance with an embodiment. With reference to the graphical representation 400, the third line 410 illustrates that the gains are substantial and in the order of ˜0.5-2.5 dB, and the gains are larger for the smaller number of M modulation symbols (e.g., for M=48).

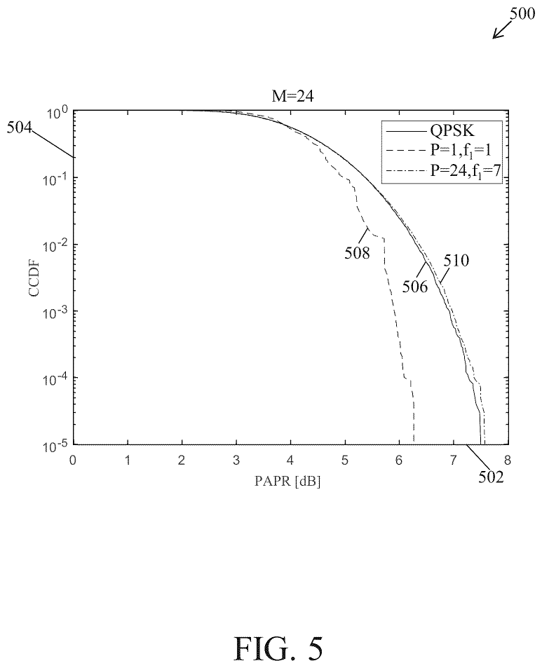

FIG. 5 depicts a graphical representation that illustrates a relation between peak-to-average-power-ratio (PAPR) and Complementary Cumulative Distribution Function (CCDF), in accordance with an embodiment of the present disclosure. FIG. 5 is described in conjunction with elements from FIGS. 1A, 1B, and 1C. With reference to FIG. 5, there is shown a graphical representation 500, that includes a X-axis 502, which illustrates PAPR ranging from 0 to 8 and a Y-axis 504 that illustrates the value of CCDF ranging from 10⁻⁵ to 10⁰.

With reference to the graphical representation 500, a first line 506, a second line 508, and a third line 510 illustrate the relation between the PAPR and the CCDF for different modulation schemes by using an up-sampling factor of 10. For example, the first line 506 illustrates the relation between the PAPR and the CCDF for the conventional QPSK. Similarly, the second line 508 illustrates the relation between the PAPR and the CCDF for the conventional BPSK with P=1, ƒ₁=1. Moreover, the third line 510 illustrates the relation between the PAPR and the CCDF for the disclosed BPSK with P=M=24 and ƒ₁=7, in accordance with an embodiment. Moreover, the graphical representation 500 illustrates that the PAPR of the disclosed BPSK with P=M=24 and ƒ₁=7 is same as that of the conventional QPSK. Similar results are obtained when M=120 modulation symbols are considered for modulation schemes at the up-sampling factor of 10. However, in another implementation scenario, when the π/2-BPSK with SSB transmission is compared with the conventional QPSK. In such scenario, the PAPR for the π/2-BPSK with SSB transmission is approximately 1 dB lower than the conventional QPSK.

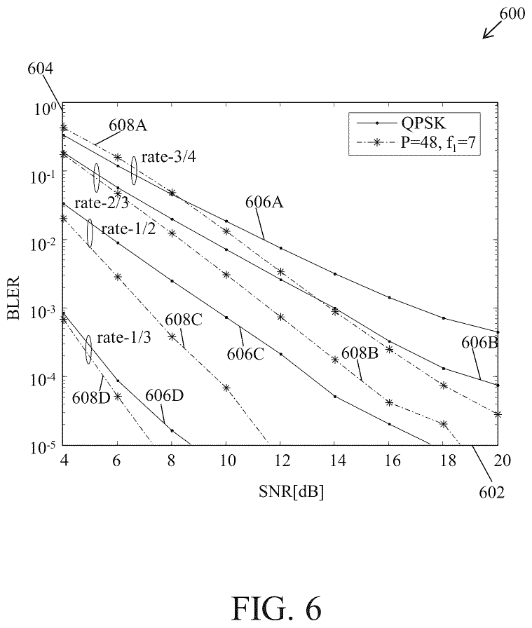

FIG. 6 depicts a graphical representation that illustrates a relation between block error rate (BLER) and signal-to-noise ratio (SNR), in accordance with an embodiment of the present disclosure. FIG. 6 is described in conjunction with elements from FIGS. 1A, 1B, and 1C. With reference to FIG. 6, there is shown a graphical representation 600 that includes a X-axis 602 that illustrates SNR ranging from 4 dB to 20 dB and a Y-axis 604 that illustrates the value of BLER ranging from 10⁻⁵ to 10⁰.

The graphical representation 600 shows a comparison of the BPSK with P=M=48 and ƒ₁=7 with the conventional QPSK. With reference to the graphical representation 600, a first line 606A, a second line 606B, a third line 606C, a fourth line 606D, a fifth line 608A, a sixth line 608B, a seventh line 608C, and an eighth line 610D collectively illustrate the relation between the BLER and the SNR for different code rates on a vehicular A channel at 500 km/h, such as at a code rate of 1/3, 1/2, 2/3, and 3/4. For example, each of the first line 606A, the second line 606B, the third line 606C, and the fourth line 606D illustrates the relation between the BLER and the SNR for the conventional QPSK. Moreover, each of the fifth line 608A, the sixth line 608B, the seventh line 608C, and the eighth line 608D illustrates the relation between the BLER and the SNR for the BPSK with P=48 (i.e., P=M), ƒ₁=7, in accordance with an embodiment. Moreover, from FIG. 6, it is illustrated that at a BLER=10⁻³, the SSB transmission with the code rate of 3/4 (i.e., for the first line 606A and the fifth line 608A) achieves the same BLER as the conventional QPSK with the code rate of 2/3, which corresponds to a throughput gain of 12.5%, as shown in FIG. 6. Practically, a control channel, such as physical uplink control channel (PUCCH) or physical downlink control channel (PDCCH) typically targets a BLER of 10⁻², while URLLC applications have been defined with the BLERs for physical uplink shared channel (PUSCH) and physical downlink shared channel (PDSCH) in the range 10⁻³ to 10⁻⁸, and V2X applications 10⁻² to 10⁻⁵.

According to the evaluations, the signal transmission apparatus 102 improves the reliability for transmissions of small and moderate payloads on channels with Doppler shift. The PAPR can be reduced (e.g., a reduction of 1 dB). The lower BLER of SSB transmission implies that a smaller SNR (e.g., ˜0.5-2.5 dB) is required for supporting the same reliability as for QPSK. Alternatively, SSB transmission may use a higher code rate, and thereby have higher spectral efficiency than QPSK, while providing the same BLER. The disclosed SSB transmission scheme is anticipated to be used instead of QPSK:
When the Doppler frequency is non-negligible compared to the subcarrier spacing.
   The Doppler frequency depends on both the UE velocity and the carrier frequency.
For small or moderate transport block sizes.
   The gains are expected to be larger for small block sizes, since the coding gain is smaller and the effect of the Doppler frequency is larger.
For small BLERs, e.g., below 0.1%.
   For small BLERs, the required SNR is sufficiently large in order for the effect of the Doppler frequency to dominate, while it is expected that the transmission becomes noise-limited at low SNRs.
For coverage limited scenarios
   The conventional QPSK has much larger PAPR than SSB transmission with π/2-BPSK.

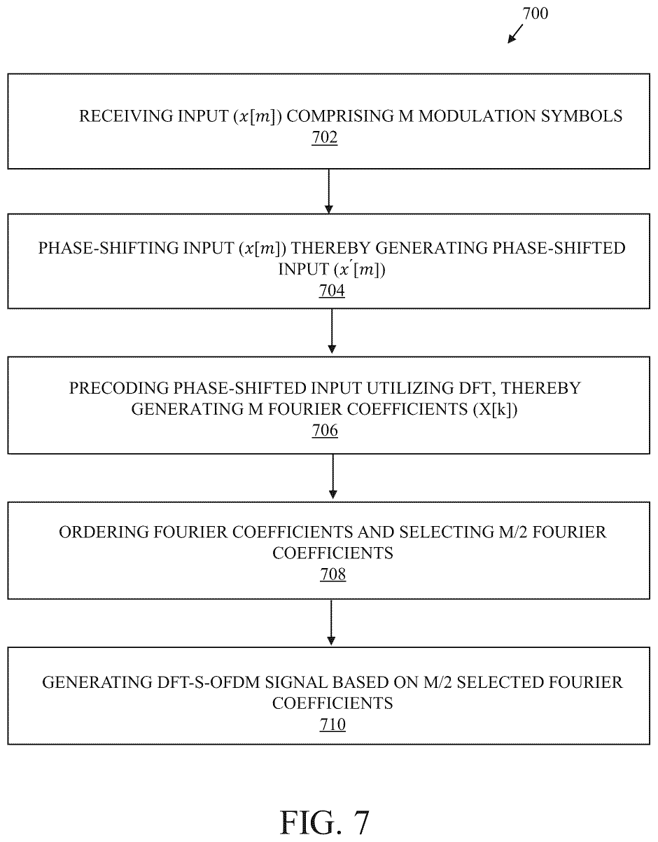

FIG. 7 is a flowchart of a method for use in a signal transmission apparatus, in accordance with an embodiment of the present disclosure. FIG. 7 is described in conjunction with elements from FIGS. 1A, 1B, and 1C. With reference to FIG. 7, there is shown a method 700 for use in the signal transmission apparatus 102 (of FIG. 1A). The method 700 includes steps 702-to-710. The signal transmission apparatus 102 is configured to execute the method 700.

There is provided the method 700 for use in the signal transmission apparatus 102 configured for transmission of modulation symbols utilizing orthogonal frequency-division multiplexing, OFDM, based on Discrete Fourier Transform, DFT, precoding. The modulation symbols are multiplexed in both time and frequency domain which provides diversity gains in time-frequency selective channels. Furthermore, the modulation symbols are pre-coded using the DFT precoding. The method 700 is applicable for transmission of small payloads, large reliability requirement and significant velocities, that is defined for URLLC and V2X.

At step 702, the method 700 comprises generating a DFT-s-OFDM signal by receiving an input (x[m]) comprising M modulation symbols. The input (x[m]) comprises M modulation symbols for m=0, 1, . . . , M−1. The input symbols (x[m]) are real-valued modulation symbols and M is an even number.

At step 704, the method 700 further comprises generating the DFT-s-OFDM signal by phase-shifting the input (x[m]) thereby generating a phase-shifted input (\acute{x}[m]). The input (x[m]) is phase shifted by use of the phase shifter 112 (of FIG. 1C) in order to generate the phase-shifted input (\acute{x}[m]), have been described in detail, for example, in FIG. 1C.

At step 706, the method 700 further comprises generating the DFT-s-OFDM signal by precoding the phase-shifted input utilizing DFT, thereby generating M Fourier coefficients (X[k]). The phase-shifted input (\acute{x}[m]) is precoded by use of DFT precoding in order to generate the M Fourier coefficients (X[k]), have been described in detail, for example, in FIG. 1C.

At step 708, the method 700 further comprises generating the DFT-s-OFDM signal by ordering the Fourier coefficients and selecting M/2 Fourier coefficients. The generated M Fourier coefficients (X[k]) are ordered and M/2 Fourier coefficients are selected, have been described in detail, for example, in FIG. 1C.

At step 710, the method 700 further comprises generating the DFT-s-OFDM signal based on the M/2 selected Fourier coefficients. The DFT-s-OFDM signal is generated by use of the signal generator 116 (of FIG. 1C) based on the M/2 selected Fourier coefficients, have been described in detail, for example, in FIG. 1C.

The steps 702-to-710 are only illustrative and other alternatives can also be provided where one or more steps are added, one or more steps are removed, or one or more steps are provided in a different sequence without departing from the scope of the claims herein.

In one aspect, a computer program product is provided that comprises program instructions for performing the method 700 when executed by one or more processors (e.g., the processor 120) in the signal transmission apparatus 102. In another aspect, a computer system is provided comprising one or more processors (e.g., the processor 120) and one or more memories (e.g., the memory 118), the one or more memories (i.e., the memory 118) storing program instructions which, when executed by the one or more processors (i.e., the processor 120), cause the one or more processors (i.e., the processor 120) to execute the method 700. In yet another aspect, the present disclosure provides a non-transitory computer-readable medium having stored thereon, computer-implemented instructions that, when executed by a computer, causes the computer to execute operations of the method 700.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A signal transmission apparatus (102) configured for transmission of modulation symbols utilizing orthogonal frequency-division multiplexing, OFDM, based on Discrete Fourier Transform, DFT, precoding, the signal transmission apparatus (102) being further configured to generate a DFT spread OFDM, DFT-s-OFDM, signal by:
receiving an input (x[m]) comprising M modulation symbols for m=0, 1, . . . , M−1, where M is an even number;
phase-shifting the input (x[m]) thereby generating a phase-shifted input (\acute{x}[m]);
precoding the phase-shifted input utilizing DFT, thereby generating M Fourier coefficients (X[k]);
ordering the Fourier coefficients and selecting M/2 Fourier coefficients; and
generating the DFT-s-OFDM signal based on the M/2 selected Fourier coefficients.

2. The signal transmission apparatus (102) according to claim 1, wherein the generated DFT-s-OFDM signal additionally comprises a cyclic prefix.

3. The signal transmission apparatus (102) according to claim 1, wherein a time-discrete low-pass equivalent signal is generated by:
$$s [ n ] = \frac{1}{\sqrt{N}} {\sum }_{k = 0}^{M / 2 - 1} X [ g [ k ] ] {e}^{j \frac{2 π}{N} nq [ k ]} , n = 0 , 1 , … , N - 1$$
wherein N denotes the number of time samples, the q[k] is a function which maps Fourier coefficients to subcarriers, and wherein g[k] is a function for selecting and ordering the Fourier coefficients.

4. The signal transmission apparatus (102) according to claim 3, where the g[k] function is configured to provide consecutive indices from 0 to (M/2−1).

5. The signal transmission apparatus (102) according to claim 3, where the g[k] function is configured to provide non-consecutive indices.

6. The signal transmission apparatus (102) according to claim 5, where the g[k] function is defined as:
$$g [ k ] = f [ h [ k ] ] \\ with the function \\ f [ i ] = {f}_{1} i + {f}_{0} ( mod M ) \\ and the function \\ h [ k ] = k + M / P ⌊ k / ( M / P ) ⌋$$
wherein M/P and P are integers and also the coefficients ƒ₁ and ƒ₀ are integers, for which the greatest common divisor of ƒ₁ and M is 1, and k=0, 1, . . . , M/2−1, and (mod M) denotes addition modulo M and └.┘ denotes the floor function.

7. The signal transmission apparatus (102) according to claim 6, wherein P is equals to 1 and ƒ₁ is equals to 2.

8. The signal transmission apparatus (102) according to claim 6, wherein P is equals to M and ƒ₁ is set as the smallest integer larger than 1 such that the greatest common divisor of ƒ₁ and M is 1.

9. The signal transmission apparatus (102) according to claim 6, wherein the function ƒ[i] is arranged to produce other indices than the corresponding h[k].

10. The signal transmission apparatus (102) according to claim 1, wherein the phase-shift for modulation symbol m is obtained from the complex exponential function e^{j(αm}^{²}^{+βm+γ)} and the phase-shifted input (\acute{x}[m]) is determined by:
$${x}^{′} [ m ] = {e}^{j ( α {m}^{2} + β m + γ )} x [ m ] , m = 0 , 1 , … , M - 1$$
wherein α, β and γ are real-valued.

11. The signal transmission apparatus (102) according to claim 10, wherein α=0.

12. The signal transmission apparatus (102) according to claim 10, wherein parameters of the function g[k] are determined to provide orthogonal signaling, by fulfilling:
$$C \cdot Re \{ {\sum }_{n = 0}^{M - 1} w [ m , n ] {w}^{*} [ p , n ] \} = δ [ m - p ]$$
where C is a constant, δ[t] is the Kronecker delta function for an integer t, Re{ } is the real-part operator and * denotes complex conjugate, wherein w[m, n] is defined for m=0, 1, . . . , M−1 and n=0, 1, . . . , N−1 as:
$$w [ m , n ] = \frac{1}{M} {\sum }_{k = 0}^{M / 2 - 1} {e}^{j ( α {m}^{2} + β m + γ )} {e}^{- j \frac{2 π}{M} g [ k ] m} {e}^{j \frac{2 π}{M} q [ k ] n}$$

13. The signal transmission apparatus (102) according to claim 1, wherein the mapping q[k] is to a set of contiguous sub carriers.

14. The signal transmission apparatus (102) according to claim 1, wherein the mapping q[k] is to a set of non-contiguous subcarriers.

15. The signal transmission apparatus (102) according to claim 1, wherein the input symbols (x[m]) are real-valued modulation symbols.

16. The signal transmission apparatus (102) according to claim 1, wherein the input symbols (x[m]) are based on a π/2-rotated Pulse Amplitude Modulation, PAM, scheme, wherein a=0, β=π/2, P=1 and ƒ₁=1, with ƒ₀=(M+2)/4.

17. The signal transmission apparatus (102) according to claim 1, wherein the input symbols (x[m]) are based on a Zadoff-Chu sequence.

18. A method (700) for use in a signal transmission apparatus (102) configured for transmission of modulation symbols utilizing orthogonal frequency-division multiplexing, OFDM, based on Discrete Fourier Transform, DFT, precoding, the method (700) comprising generating a DFT spread OFDM, DFT-s-OFDM, signal by:
receiving an input (x[m]) comprising M modulation symbols, where M is an even number;
phase-shifting the input (x[m]) thereby generating a phase-shifted input (\acute{x}[m]);
precoding the phase-shifted input utilizing DFT, thereby generating M Fourier coefficients (X[k]);
ordering the Fourier coefficients and selecting M/2 Fourier coefficients; and
generating the DFT-s-OFDM signal based on the M/2 selected Fourier coefficients.

19. The method (700) according to claim 18, wherein a time-discrete low-pass equivalent signal is generated by:
$$s [ n ] = \frac{1}{\sqrt{N}} {\sum }_{k = 0}^{M / 2 - 1} X [ g [ k ] ] {e}^{j \frac{2 π}{N} nq [ k ]} , n = 0 , 1 , … , N - 1$$
wherein N denotes the number of time samples, the q[k] is a function which maps Fourier coefficients to subcarriers, and wherein g[k] is a function for selecting and ordering the Fourier coefficients.

20. The method (700) according to claim 19, where the g[k] function is configured to provide consecutive indices from 0 to (M/2−1).
